(19) United States
(12) Patent Application Publication
(10) Pub. No.: US 2016/0026105 A1
(43) Pub. Date: Jan. 28, 2016

(54) CARRIER FOR DEVELOPING ELECTROSTATIC IMAGE, ELECTROSTATIC IMAGE DEVELOPER, PROCESS CARTRIDGE, AND IMAGE FORMING APPARATUS

(71) Applicant: FUJI XEROX CO., LTD., Tokyo (JP)

(72) Inventors: Yosuke TSURUMI, Minamiashigara-shi (JP); Takeshi SHOJI, Ebina-shi (JP); Hiroshi KAMADA, Minamiashigara-shi (JP)

(21) Appl. No.: 14/608,881

(22) Filed: Jan. 29, 2015

(30) Foreign Application Priority Data
Jul. 23, 2014 (JP) 2014-150091
Jul. 23, 2014 (JP) 2014-150092

(51) Int. Cl. G03G 9/00

(52) U.S. Cl. CPC G03G 9/1075; G03G 15/095; G03G 9/1132

(57) ABSTRACT

There is provided a carrier for developing an electrostatic image, comprising: magnetic particles, wherein the magnetic particles has a flow rate of 25 sec/50 g to 30 sec/50 g, and the magnetic particles satisfy an expression of 1.00≦LR/HR≦1.15, wherein HR represents a resistance under an electric field of 19200 V/cm at a temperature of 30° C. and a relative humidity of 85%, and LR represents a resistance under an electric field of 19200 V/cm at a temperature of 10° C. and a relative humidity of 15%.

### CROSS-REFERENCE TO RELATED APPLICATION(S)

This application is based on and claims priority under 35 U.S.C. 119 from Japanese Patent Application Nos. 2014-150091 filed on Jul. 23, 2014 and 2014-150092 filed on Jul. 23, 2014.

### BACKGROUND

1. Technical Field

The present invention relates to a carrier for developing an electrostatic image, an electrostatic image developer, a process cartridge, and an image forming apparatus.

2. Related Art

An electrophotographic method is a method in which an image can be obtained by developing an electrostatic latent image formed on the surface of an image holding member (photoreceptor) using a toner including a coloring agent, transferring the obtained toner image to the surface of a recording medium, and fixing the toner image using a heat roll or the like. Further, in the latent image holding member, a cleaning process may be omitted when the residual toner is cleaned for once again forming an electrostatic latent image and the residual toner is almost depleted as the case where a spherical toner is used. Dry developers used for such an electrophotographic method are largely divided into a single-component developer only using a toner obtained by blending a coloring agent or the like with a binder resin and a two-component developer obtained by mixing a carrier with the toner.

### SUMMARY

According to one aspect of the invention, there is provided a carrier for developing an electrostatic image, including: magnetic particles, wherein the magnetic particles has a flow rate of 25 sec/50 g to 30 sec/50 g, and the magnetic particles satisfy an expression of 1.00≦LR/HR≦1.15, wherein HR represents a resistance under an electric field of 19200 V/cm at a temperature of 30° C. and a relative humidity of 85%, and LR represents a resistance under an electric field of 19200 V/cm at a temperature of 10° C. and a relative humidity of 15%.

### BRIEF DESCRIPTION OF THE DRAWINGS

Exemplary embodiments of the present invention will be described in detail based on the following figure, wherein:

FIG. 1 is a configuration view schematically illustrating an example of an image forming apparatus according to an exemplary embodiment;

FIG. 2 is a configuration view schematically illustrating an example of a process cartridge according to an exemplary embodiment; and

FIG. 3 is a configuration view schematically illustrating an example of an image forming apparatus according to an exemplary embodiment.

### DETAILED DESCRIPTION

Hereinafter, an embodiment which is an example of the present invention will be described.

<Carrier for Developing Electrostatic Image>

A carrier for developing an electrostatic image according to the exemplary embodiment (hereinafter, also simply referred to as a “carrier”) includes magnetic particles which satisfy an expression of 1.00≦LR/HR≦1.15 when resistance under an electric field of 19200 V/cm in an environment of a temperature of 30° C. and a relative humidity of 85% (hereinafter, also referred to as “the high temperature and the high humidity”) is set as HR and resistance under an electric field of 19200 V/cm in an environment of a temperature of 10° C. and a relative humidity of 15% (hereinafter, also referred to as “the low temperature and the low humidity”) is set as LR, and the flow rate thereof is from 25 sec/50 g to 30 sec/50 g.

Image formation using an electrophotographic system is generally performed by the following process. A developer in a developing device is stirred and charged. The charged developer is conveyed to a developer holding member of the developing device and an electrostatic latent image formed on the surface of an electrophotographic photoreceptor facing the developer holding member is developed by a toner.

Developing properties of the toner are easily affected by the temperature and the humidity. Generally, charging of a developer is unlikely to be generated in a high temperature and high humidity environment. Particularly, when the resistance of the carrier is low, the charge easily leaks from the carriage so that the charging becomes low. In contrast, the charging is likely to be high in a low temperature and low humidity environment. This is because influence of moisture due to the low humidity is small and the charge is easily accumulated on the developer.

In a case where printing with high density is continued in a high temperature and high humidity environment, since charging is difficult, the toner is frequently replaced, and the stirring time of the toner and the carrier becomes short, the charging becomes more difficult. At this time, the developing properties become excessive under low charging in many cases and the potential of the developing device and the photoreceptor is adjusted such that developing is suppressed on the image forming apparatus side.

When moved to a low temperature and low humidity environment in this state, since the developing properties of the image forming apparatus are degraded and the charging of the developer becomes high so that the developing properties are degraded, the image density becomes low. At this time, the toner density is raised for lowering the charging. However, the charging unevenness in the developer becomes easily generated due to a sudden replenishment of a toner and the charging unevenness leads to the density unevenness of an image in many cases.

That is, particularly, when the state in which an image with high image density is formed in a high temperature and high humidity environment is changed to a state in which an image with low image density is formed in a low temperature and low humidity environment, the charging of the developer becomes high, the toner density is increased, and the charging is adjusted. At this time, since the stirring and charging of the developer cannot keep up with the change of the environment and the change in the toner density, the charging unevenness is easily generated and this easily leads to unevenness in an image.

Further, in a trickle type that performs developing while replacing a carrier by adding a small amount of carrier to a developer cartridge, replenishing a developing device with the toner and the carrier, and discharging a small amount of carrier from the developing device, the carrier which is present in the developer cartridge is in a state of being unevenly mixed in some cases, the replenishing amount of the carrier supplied to the developing device fluctuates, and thus, the charging unevenness is generated and the density unevenness of an image may be generated while the developing device is replenished with the carrier.

Meanwhile, the change in the density of an image at the time when the temperature, the humidity, and the image density fluctuate is suppressed using the carrier according to the embodiment. The reason thereof is assumed as follows.

In the carrier according to the exemplary embodiment, since the fluidity of magnetic particles serving as a core material is high and the stirring properties of a developer are excellent, the change of the environment and the charging unevenness due to the replenishment of a toner are unlikely to be generated. Further, the change in the charging due to the change of the environment is unlikely to be suppressed by simply increasing the fluidity, but it is considered that since excellent stirring is performed in a state in which the leakage of the charge on the surface of the carrier is only slightly changed due to the environment (temperature and humidity) and the charge on the surface is stabilized when the fluidity and the resistance ratio (LR/HR) of magnetic particles are respectively in the above-described specific ranges, the change of the charging in the developer is small and an image whose density unevenness is suppressed can be obtained even when replenishment of the toner accompanied by the change of the environment is performed. It is considered that this effect can be obtained for the first time by achieving a balance between the change in the charge on the surface of the carrier and the stirring properties in a desired range.

Also, the residual toner remaining on the surface of the photoreceptor is collected by a cleaning blade or the like. In an image forming apparatus with a so-called reclaim system that recycles the collected toner, the collected toner is returned to the developing device again. In this manner, the toner reused by collecting the residual toner from the surface of the photoreceptor (hereinafter, also referred to as a “reclaim toner”) is a toner having charging failures or a distorted shape of a toner in many cases. The charging of the reclaim toner is unstable and the toner is unlikely to be charged even when the toner is returned to the developing device. When a new toner is supplied from a cartridge together with the reclaim toner and both toners are mixed with each other, the charging of the new toner is high and the charging of the reclaim toner is low so that the width of charging distribution is likely to be widened.

On contrary, in a high temperature and high humidity environment, low charging progresses and easily appears as fogging. Further, in a low temperature and low humidity environment, high charging progresses, density unevenness is easily generated by the charging distribution being widened. Particularly, in a case where an image with high density is continuously formed, since an amount of the reclaim toner and a new toner to be supplied from a cartridge is large, it is difficult to suppress both of fogging and density unevenness.

Meanwhile, the density unevenness of an image obtained by performing image formation in a high temperature and high humidity environment and then performing image formation in a low temperature and low humidity is suppressed using the carrier according to the exemplary embodiment in the image formation with the reclaim system. The reason thereof is assumed as follows.

When the carrier for a reclaim system according to the exemplary embodiment is used, widening of the charging distribution is suppressed because of high stirring properties of a developer even when the reclaim toner and the new toner are mixed with each other.

When the ratio (resistance ratio) of the resistance in a high temperature and high humidity environment to the resistance in a low temperature and low humidity environment of magnetic particles is in a specific range in the exemplary embodiment, fluctuation in charge of the surface of the carrier due to the change of the environment is suppressed. When the charge of the surface varies, an attractive force between the toner and the carrier varies according to the charge, and accordingly, stirring failures are easily generated. Therefore, the stirring properties of the developer become excellent when the fluctuation in the charge of the surface is suppressed. When the flow rate of the magnetic particles is in a specific range in the exemplary embodiment, the variance of the stirring properties of the developer is easily suppressed regardless of the high temperature and high humidity environment or the low temperature and low humidity environment. As a result, when the widening of the charging of the toner is suppressed even in the case of image formation with the reclaim system, image formation is performed in a high temperature and high humidity environment, and then image formation is performed in a low temperature and low humidity environment, the density unevenness of an image is suppressed.

Moreover, the carrier according to the exemplary embodiment may be formed of only magnetic particles or may be a resin-coated carrier in which a part of the surface of magnetic particles serving as a core material is coated with a coating layer containing a resin, but when the fluidity of the resin-coated carrier and the ratio (resistance ratio) of the resistance in a high temperature and high humidity environment to the resistance in a low temperature and low humidity environment are respectively in the above-described specific ranges, the coated state becomes uneven and the developer becomes deteriorated since the resin-coated carrier is affected by the coated state of the resin; and a difference between a carrier in a developing device and a carrier to replenish the developing device makes the stirring properties and the charging properties of the developer unstable in a case of the trickle type.

On the contrary, in the carrier according to the exemplary embodiment, it is considered that the influence of the coated state of a resin is eliminated and the stirring properties and the charging properties of the developer are stabilized so that the density unevenness of an image is suppressed by respectively setting the fluidity and the resistance ratio of the magnetic particles serving as a core material of the carrier in the above-described specific ranges.

Further, in a case where a developing device is replenished with the carrier according to the exemplary embodiment using the trickle type, it is considered that the stirring properties are excellent and the charging unevenness is suppressed even when the environment is changed, and thus the fluctuation in charging is suppressed.

Hereinafter, as a typical example of the carrier according to the exemplary embodiment, the resin-coated carrier in which the surface of the magnetic particles is coated with a coating layer containing a resin will be described in detail.

(Magnetic Particles)

The magnetic particles contained in the carrier according to the exemplary embodiment satisfy an expression of 1.00≦LR/HR≦1.15 when the resistance under an electric field of 19200 V/cm in an environment of a temperature of 30° C. and a relative humidity of 85% is set as HR and the resistance under an electric field of 19200 V/cm in an environment of a temperature of 10° C. and a relative humidity of 15% is set as LR, and the flow rate thereof is in a range of 25 sec/50 g to 30 sec/50 g.

The resistance ratio (LR/HR) is preferably in the range of 1.00≦LR/HR≦1.15 and more preferably in the range of 1.01≦LR/HR≦1.10. When the resistance ratio (LR/HR) is less than 1.00, since the resistance value with respect to the environment becomes reversed and the effect thereof becomes opposite with respect to the fluctuation of the environment, the density unevenness accompanied by the fluctuation of the environment is not suppressed. Meanwhile, when the resistance ratio (LR/HR) is more than 1.15, the fluctuation in the charging with respect to the fluctuation of the environment becomes large, and the density unevenness is not suppressed.

Moreover, in the magnetic particles according to the exemplary embodiment, from a viewpoint of suppressing fluctuation in the image density due to the change in the temperature and the humidity, the resistance HR under an electric field of 19200 V/cm in an environment of a temperature of 30° C. and a relative humidity of 85% is preferably from 6 log Ωcm to 10 log Ωcm and more preferably from 7 log Ωcm to 9 log Ωcm in terms of a common logarithm.

Moreover, in the magnetic particles according to the exemplary embodiment, from a viewpoint of suppressing fluctuation of the image density due to the change in the temperature and the humidity, the resistance LR under an electric field of 19200 V/cm in an environment of a temperature of 10° C. and a relative humidity of 15% is preferably from 6 log Ωcm to 10 log Ωcm and more preferably from 7 log Ωcm to 9 log Ωcm in terms of a common logarithm.

In addition, the above-described resistance of the magnetic particles according to the exemplary embodiment is measured as follows. In an environment of a high temperature and a high humidity (30° C., relative humidity of 85%) or a low temperature and low humidity (10° C., relative humidity of 15%), two sheets of polar plates are allowed to face each other in parallel with a width of 1 mm, 0.25 g of magnetic particles are put therebetween, the magnetic particles are held using a magnet with a cross-sectional area of 2.4 cm², an applied voltage of 800 V is applied thereto, and an current value is measured. The electric field at the time is 19200 V/cm. The resistance value is calculated from the obtained current value.

Further, the flow rate of the magnetic particles according to the exemplary embodiment is from 25 sec/50 g to 30 sec/50 g and preferably from 26 sec/50 g to 28 sec/50 g. When the flow rate of the magnetic particles is less than 25 sec/50 g, since the fluidity becomes exceedingly excellent, the frictional charging with the toner is unlikely to be generated in some cases. Meanwhile, when the flow rate of the magnetic particles is more than 30 sec/50 g, the stirring properties become deteriorated and the charging unevenness easily becomes generated. As a result, the unevenness of the image density easily becomes generated.

As a material constituting the magnetic particles, ferrite having a structure represented by the following formula can be exemplified.

(MO)_{X}(Fe₂O₃)_{Y} Formula

In the formula described above, M represents at least one element selected from a group consisting of Cu, Zn, Fe, Mg, Mn, Ca, Li, Ti, Ni, Sn, Sr, Al, Ba, Co, and Mo. Further, X and Y represent a molar ratio and X+Y is 100.

When M represents plural metals, examples of the ferrite having a structure represented by the formula described above include known ferrites such as manganese-zinc ferrite, nickel-zinc ferrite, manganese-magnesium ferrite, and copper-zinc ferrite.

In the magnetic particles according to the exemplary embodiment, the resistance ratio and the fluidity may be respectively in the above-described ranges, and manganese ferrite is preferable as the ferrite. The manganese ferrite contains at least Fe and Mn as metals and the balance between the magnetization and the resistance is excellent. In addition, manganese ferrite may contain metals other than Fe and Mn and examples thereof include Mn—Mg ferrite and Mn—Zn ferrite.

The volume average particle diameter (D50v) of the magnetic particles used in the present exemplary embodiment may be from 30 μm to 50 μm.

The volume average particle diameters of the magnetic particles in the exemplary embodiment and pulverized particles are a value measured using a laser diffraction particle size distribution measuring device (for example, LA-700, manufactured by Horiba, Ltd.). The particle diameter corresponding to 50% accumulation measured by drawing cumulative distribution of the volume from the small diameter side with respect to the divided particle size range (channel) based on the obtained particle size distribution is set as the volume average particle diameter (D50v).

A method of producing the magnetic particles according to the exemplary embodiment is not particularly limited, but the magnetic particles can be produced by adjusting the addition amount of SiO₂ including the amount of Si as impurities, adding CaCO₃, firing the resultant, and applying a combination of heat treatments in an environment of a relatively low temperature.

Hereinafter, an example of the method of producing the magnetic particles according to the exemplary embodiment will be described by showing specific materials and conditions, but the magnetic particles according to the exemplary embodiment are not limited to the materials or numerical values described below.

It is necessary that a magnetic substance used for the carrier is magnetized in a magnetic field similar to cases of soft ferrite or magnetite and the magnetization thereof is decreased by the magnetic substance being separated from the magnetic field. Similar to a case of hard ferrite, when the magnetic substance is magnetized once and the magnetic substance whose magnetization is stored is used for a carrier, a phenomenon in which carriers attract each other in a developing device or repel each other occurs, and the developer is unlikely to be stirred. Accordingly, the charging of the developer becomes insufficient and problems are likely to occur in an image.

In the related art, it is difficult for magnetite or soft ferrite to satisfy physical properties of the magnetic particles according to the exemplary embodiment. In addition, magnetite is a crystal substance formed of iron and oxygen and iron has divalent iron ions and trivalent iron ions in a state in which oxygen is interposed therebetween. The electrons move easily through oxygen and movement of the electrons becomes easier in a high electric field. Consequently, it is difficult to have sufficient resistance in the electric field of the present exemplary embodiment. When the soft ferrite has other metal ions other than iron and oxygen, movement of electrons in the system is suppressed so that the resistance in the high electric field can be easily maintained. Examples of the metal used for the soft ferrite include Li, Mg, Ti, Cr, Mn, Co, Ni, Cu, and Zn. In these metals, it is necessary to use an element having low affinity for water in order to obtain the resistance ratio with respect to the temperature and the humidity of the present exemplary embodiment. Examples thereof include Cr, Mn, Co, Ni, Cu, and Zn. However, since these elements have high melting temperatures and the roughness of the surface of the particles cannot be sufficiently controlled by the firing temperature at the time when ferrite is prepared, the fluidity becomes degraded.

The ferrite is formed by heating a metal oxide in an atmosphere in which nitrogen and oxygen are mixed and by promoting a reaction in a reduction direction. Ferritization has a preferred temperature range and the range varies according to the contained elements, but the range thereof is generally 1000° C. to 1400° C. In the combination of the above-described elements, the temperature is required to be 1400° C. or higher in order to control the surface. At this time, the reduction further progresses in ferrite and magnetization is lost in some cases.

In order to obtain the fluidity of the magnetic particles according to the exemplary embodiment, it is necessary for the surface of the magnetic particles to have target roughness. An element whose melting temperature is low can be used for controlling the surface of the magnetic particles. However, the element whose melting temperature is low is an element having high affinity for water, such as alkali metal or alkaline-earth metal. Therefore, in regard to a magnetic substance using these elements, it is difficult to control the resistance ratio due to the temperature and the humidity to be from the present exemplary embodiment.

In this manner, a target magnetic substance can be obtained using the following method.

The magnetic substance is formed of elements with high melting temperatures without using metals with low melting temperatures, which is the factor that deteriorates the resistance ratio due to the temperature and the humidity. Further, in the elements with high melting temperatures, manganese which becomes an ion having 4 or 5 lone electrons in the inner core necessary for obtaining magnetization can be preferably used.

Oxides of iron (Fe) and manganese (Mn) are weighed such that the molar ratio of the iron to the manganese becomes 2 to 1. Next, the amount of Si contained in each oxide is measured using fluorescent X-rays and SiO₂ in an amount in which the content of Si with impurities become 0.8% by mass is added to the oxides of iron and manganese.

Subsequently, polycarboxylic acid, water, and polyvinyl alcohol are added as a dispersant, and mixing and pulverizing are performed using zirconia beads having a media diameter of 1 mm.

Next, granulating and drying are performed using a spray drier such that particles have a volume average particle diameter of 38 μm.

The dried particles are heated at 1000° C. for 6 hours and then heated at 1400° C. for 2 hours in an electric furnace. At this time, the particles are fired while the oxygen concentration in a mixture gas of oxygen and nitrogen is adjusted to be 1%.

The particles are heated at 800° C. for 8 hours in an atmospheric state after being heated at 1400° C. for 2 hours.

Subsequently, target magnetic particles having a diameter of 35 μm can be obtained after a crushing process and a classifying process are performed.

The surface roughness of magnetic particles can be controlled by controlling the amount of Si and by adding CaCO₃. SiO₂ controls the size of the surface roughness according to the amount thereof and CaCO₃ controls the height of the roughness. The flow rate becomes smaller as the surface roughness becomes larger and the height thereof is lower.

As the conditions of the firing, ferritization is promoted while the surface shape is formed at a low temperature in order to uniformize the surface roughness, ferritization is performed in order to obtain magnetization at a high temperature for a short period of time, and then the particles are heated at a low temperature in order to make the surface smooth.

(Coating Layer)

Examples of the resin (coated resin) contained in the coating layer which is applied to the magnetic particles include a straight silicone resin formed by containing polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, an alkyl (meth)acrylate resin, or an organosiloxane bond, or a modified product thereof; a fluorine resin, polyester, polycarbonate, a phenol resin, and an epoxy resin. Here, “(meth)acrylate” means acrylate or methacrylate.

It is preferable that the coating layer includes a resin having a cycloalkyl group. Examples of the resin having a cycloalkyl group include (1) a homopolymer of a monomer including a cycloalkyl group; (2) a copolymer obtained by polymerizing two or more kinds of monomers including a cycloalkyl group; and (3) a copolymer of a monomer including a cycloalkyl group and a monomer not including a cycloalkyl group.

Excessive charging of a toner in a low temperature and low humidity is suppressed using a resin including a cycloalkyl group in a coating layer and thus the density unevenness of an image is further suppressed.

In the above-described (1) to (3), as the cycloalkyl group, a cycloalkyl group of 3-membered to 10-membered rings is exemplified, a cycloalkyl group of 3-membered to 8-membered rings (3 to 8 carbon atoms) is preferable and a cycloalkyl group (cyclopentyl or cyclohexyl) of 5-membered and 6-membered rings (5 and 6 carbon atoms) is more preferable from a viewpoint of stabilizing the charge of the surface of the carrier. In a case of a cycloalkyl group having 8 or less carbon atoms, steric hindrance is small and excellent toughness of a resin can be obtained. In a case of a cycloalkyl group having 5 or 6 carbon atoms, the cyclic structure thereof is stabilized. The structure of a cycloalkyl group is specified by NMR of a resin.

As the resin having the cycloalkyl group, a resin having a polymerization unit derived from at least one kind selected from a group consisting of cycloalkyl acrylate and cycloalkyl methacrylate is preferable, and specific examples thereof include cycloalkyl acrylate, cycloalkyl methacrylate, a copolymer of cycloalkyl methacrylate and alkyl methacrylate, a copolymer of cycloalkyl acrylate and alkyl methacrylate, a copolymer of cycloalkyl methacrylate and alkyl acrylate, a copolymer of a combination of cycloalkyl acrylate, cycloalkyl methacrylate, alkyl acrylate, and alkyl methacrylate, a copolymer of cycloalkyl methacrylate and styrene, a copolymer of cycloalkyl acrylate and styrene, a polyester resin having a cycloalkyl group at the side chain, a urethane resin having a cycloalkyl group at the side chain, and a urea resin having a cycloalkyl group at the side chain.

Particularly, as the resin having the cicylalkyl group, (3) the copolymer of a monomer including the cycloalkyl group and a monomer not including a cycloalkyl group is preferable, a copolymer of at least one selected from cycloalkyl acrylate and cycloalkyl methacrylate and methyl methacrylate is more preferable, and a copolymer of cycloalkyl acrylate and methyl methacrylate is still more preferable. When the cycloalkyl group is a copolymer of cycloalkyl acrylate and methyl methacrylate, suppression of a change in charging amount is maintained. It is considered that this effect is obtained from improvement of the adhesiveness between the coating layer and the magnetic particles.

The copolymerization ratio in a copolymer of at least one of cycloalkyl acrylate and cycloalkyl methacrylate and methyl methacrylate (at least one of cycloalkyl acrylate and cycloalkyl methacrylate:methyl methacrylate, molar ratio) may be from 85:15 to 99:1.

Further, the weight average molecular weight (Mw) of a resin having a cycloalkyl group may be from 3000 to 20000.

Moreover, the weight average molecular weight is measured using a gel permeation chromatography (GPC). HLC-8120GPC and SC8020 (manufactured by Tosoh Corporation) are used as GPC, two columns of TSKGEL and SUPERHM-H (manufactured by Tosoh Corporation, 6.0 mmID×15 cm) are used as a column, and THF (tetrahydrofuran) is used as an eluent. As test conditions, under the conditions of a sample concentration of 0.5% by mass, a flow velocity of 0.6 mL/min, a sample injection amount of 10 μL, and a measurement temperature of 40° C., the test is performed using a refractive index (RI) detector (differential refractive index detector). Further, the calibration curve is prepared from ten samples of “polystyrene standard sample TSK standard”:“A-500”, “F-1”, “F-10”, “F-80”, “F-380”, “A-2500”, “F-4”, “F-40”, “F-128”, and “F-700” (manufactured by Tosoh Corporation).

Moreover, in the carrier according to the exemplary embodiment, conductive particles (particles having a volume resistivity of 1×10⁻⁶ Ωcm or less at 20°) may be dispersed in the coating layer. Examples of the conductive particles include metal such as gold, silver, or copper, carbon black, titanium oxide, zinc oxide, barium sulfate, aluminum borate, potassium titanate, and tin oxide, but the conductive particles are not limited thereto.

Further, in a case where the carrier for developing an electrostatic image according to the exemplary embodiment is a resin-coated carrier in which a part of the surface of the magnetic particles is coated with a resin, the coating rate of the magnetic particles with respect to the coating layer is preferably from 70% to 98% and more preferably from 85% to 95% so that the carrier resistance and the fluidity depend on the magnetic particles.

Here, the coating rate thereof can be acquired by measuring the coating rate using the following method.

The carrier is fixed to a sample holder and inserted into a chamber of ESCA using ESCA-9000MX (manufactured by JEOL, Ltd.) as an X-ray electron spectrometer. The degree of vacuum of the chamber is set to 1×10⁻⁶ Pa or less, Mg-Kα is used as an excitation source, and the output is set to 200 W. Under the above-described conditions, XPS spectra of particles of a magnetic substance (magnetic particles) and the carrier are measured and the coating rate is calculated from a ratio of area intensity of a Fe peak (2p3/2) of a detected element.

Coating rate=F2/F1×100

(F1: Fe area intensity of particles of magnetic substance, F2: Fe area intensity of carrier)

Examples of the method of coating a part of the surface of magnetic particles with a resin include a method of coating the surface thereof with a solution for forming a coating layer obtained by dissolving or dispersing a resin having a cycloalkyl group or optionally various additives in an appropriate solvent. The solvent is not particularly limited and can be selected in consideration of a coating resin to be used, coating suitability, and the like.

More specific examples of the method of coating the surface with a resin include an immersion method of immersing magnetic particles in a solution for forming a coating layer; a spray method of spraying a solution for forming a coating layer to the surface of a magnetic particle; a fluidized bed method of spraying a solution for forming a coating layer in a state in which magnetic particles are floated due to a fluidized air; and a kneader coater method of mixing magnetic particles with a solution for forming a coating layer in a kneader coater and removing the solvent.

<Electrostatic Image Developer>

The electrostatic image developer (hereinafter, referred to as a developer) according to the exemplary embodiment includes a toner for developing an electrostatic image and the carrier for developing an electrostatic image described above.

The toner included in the developer according to the exemplary embodiment includes toner particles, and optionally an external additive.

(Toner Particles)

The toner particles contain, for example, a binder resin, and optionally a coloring agent, a release agent, and other additives.

—Binder Resin—

Examples of the binder resin include a vinyl resin formed of a homopolymer of monomers such as styrenes (for example, styrene, parachlorostyrene, and α-methylstyrene); (meth)acrylic acid esters (for example, acrylic acid methyl and acrylic acid ethyl, acrylic acid n-propyl, acrylic acid n-butyl, acrylic acid lauryl, acrylic acid 2-ethylhexyl, methacrylic acid methyl, methacrylic acid ethyl, methacrylic acid n-propyl, methacrylic acid lauryl, and methacrylic acid 2-ethylhexyl); ethylenically unsaturated nitriles (for example, acrylonitrile and methacrylonitrile); vinyl ethers (for example, vinyl methyl ether and vinyl isobutyl ether); vinyl ketones (vinyl methyl ketone, vinyl ethyl ketone, and vinyl isopropenyl ketone); and olefins (for example, ethylene, propylene, and butadiene) or a copolymer combining two or more kinds of these monomers.

Examples of the binder resin include a non-vinyl resin such as an epoxy resin, a polyester resin, a polyurethane resin, a polyamide resin, a cellulose resin, a polyether resin, or a modified resin; a mixture of these and the vinyl resin; and a graft polymer obtained by polymerizing vinyl-based monomers in the coexistence of these.

These binder resins may be used alone or in combination of two or more kinds thereof.

The content of the binder resin is preferably from 40% by mass to 95% by mass, more preferably from 50% by mass to 90% by mass, and still more preferably from 60% by mass to 85% by mass with respect to the entirety of toner particles.

—Coloring Agents—

Examples of coloring agents include various pigments such as Carbon Black, Chrome Yellow, Hansa Yellow, Benzidine Yellow, Threne Yellow, Quinoline Yellow, Pigment Yellow, Permanent Orange GTR, Pyrazolone Orange, Vulcan Orange, Watchung Red, Permanent Red, Brilliant Carmine 3B, Brilliant Carmine 6B, Du Pont Oil Red, Pyrazolone Red, Lithol Red, Rhodamine B Lake, Lake Red C, Pigment Red, Rose Bengal, Aniline Blue, Ultramarine Blue, Calco Oil Blue, Methylene Blue Chloride, Phthalocyanine Blue, Pigment Blue, Phthalocyanine Green, and Malachite Green Oxalate; and various dyes such as an acridine-based dye, a xanthene-based dye, an azo-based dye, a benzoquinone-based dye, an azine-based dye, an anthraquinone-based dye, a thioindigo-based dye, a dioxazine-based dye, a thiazine-based dye, an azomethine-based dye, an indigo-based dye, a phthalocyanine-based dye, an aniline black-based dye, a polymethine-based dye, a triphenylmethane-based dye, a diphenylmethane-based dye, and a thiazole-based dye.

These coloring agents may be used alone or in combination of two or more kinds thereof.

As the coloring agent, a coloring agent subjected to a surface treatment may be used according to the necessity or a combination with a dispersant may be used. In addition, the coloring agents may be used in combination of plural kinds thereof.

The content of the coloring agent is preferably from 1% by mass to 30% by mass and more preferably from 3% by mass to 15% by mass with respect to the entirety of toner particles.

—Release Agent—

Examples of the release agent include natural waxes such as a hydrocarbon-based wax, a carnauba wax, a rice wax, and a candelilla wax; synthetic or mineral and petroleum waxes such as a montan wax; and ester-based waxes such as fatty acid ester and montan acid ester. However, the release agents are not limited to these examples.

The melting temperature of the release agent is preferably from 50° C. to 110° C. and more preferably from 60° C. to 100° C.

Further, the melting temperature is acquired from a “melting peak temperature” described in a method of acquiring the melting temperature in JIS K-1987 “Method of Measuring Transition Temperature of Plastic” based on a DSC curve obtained using differential scanning calorimetry (DSC).

The content of the release agent is preferably from 1% by mass to 20% by mass and more preferably from 5% by mass to 15% by mass with respect to the entirety of toner particles.

—Other Additives—

Examples of other additives include known additives such as a magnetic substance, a charge controlling agent, and inorganic powder. These additives are contained in toner particles as internal additives.

—Characteristics of Toner Particles—

The toner particles may have a single layer structure or a so-called core-shell structure formed of a core portion (core particles) and a coating layer (shell layer) covering the core portion.

Here, the toner particles having a core-shell structure may be formed of a core portion containing a binder resin, and optionally other additives such as a coloring agent and a release agent; and a coating layer containing a binder resin.

The volume average particle diameter (D50v) of the toner particles is preferably from 2 μm to 10 μm and more preferably from 4 μm to 8 μm.

In addition, various average particle diameters and various particle size distribution indices of toner particles are measured using COULTER MULTISIZER-II (manufactured by BECKMAN COULTER) and an electrolyte solution is measured using ISOTON-II (manufactured by BECKMAN COULTER).

During the measurement, a measurement sample is added to 2 mL of a 5% aqueous solution of a surfactant as a dispersant (sodium alkylbenzene sulfonate is preferable) by an amount of 0.5 mg to 50 mg. The solution is added to 100 mL to 150 mL of an electrolyte solution.

The electrolyte solution in which the sample is suspended is subjected to a dispersion treatment in an ultrasonic disperser for 1 minute, and the particle size distribution of particles having a particle diameter from 2 μm to 60 μm is measured using an aperture having an aperture diameter of 100 μm with COULTER MULTISIZER-II. Further, the number of particles for sampling is 50000.

Cumulative distributions of the volume and the number are drawn from the small diameter side with respect to the particle size range (channel) divided based on the measured particle size distribution, and the particle diameter corresponding to 16% cumulation is defined as a volume particle diameter D16v and a number particle diameter D16p, the particle diameter corresponding to 50% cumulation is defined as a volume particle diameter D50v and a number particle diameter D50p, and the particle diameter corresponding to 84% cumulation is defined as a volume particle diameter D84v and a number particle diameter D84p.

Using these definitions, the volume average particle size distribution index (GSDv) is calculated as (D84v/D16v)^{1/2} and the number average particle size distribution index (GSDp) is calculated as (D84p/D16p)¹¹².

A shape factor SF1 of the toner particles is preferably from 110 to 150 and more preferably from 120 to 140.

In addition, the shape factor SF1 is acquired by the following equation.

SF1=(ML²/A)×(π/4)×100 Equation

In the equation, ML represents a maximum absolute length of a toner and A represents a projected area of a toner.

Specifically, the shape factor SF1 is digitized by mainly analyzing a microscope image or a scanning electron microscope (SEM) image using an image analyzer and is calculated as follows. That is, an optical microscope image of particles sprayed on the surface of slide glass is captured in an image analyzer (LUZEX) by a video camera, the maximum length and the projected area of one hundred particles are acquired, and calculation is performed using the above equation, and then the average value thereof is acquired, thereby obtaining the shape factor.

(External Additives)

As the external additive, inorganic particles are exemplified. Examples of the inorganic particles include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

The surface of inorganic particles as an external additive may be subjected to a hydrophobic treatment. The hydrophobic treatment is performed by immersing the inorganic particles in a hydrophobic treatment agent. The hydrophobic treatment agent is not particularly limited, and examples thereof include a silane-based coupling agent, silicone oil, a titanate-based coupling agent, and an aluminum-based coupling agent. These may be used alone or in combination of two or more kinds thereof.

The amount of the hydrophobic treatment agent is generally from 1 part by mass to 10 parts by mass with respect to 100 parts by mass of the inorganic particles.

Examples of the external additive include resin particles (resin particles such as polystyrene, PMMA, and a melamine resin) and cleaning activators (metal salts of higher fatty acids represented by zinc stearate and particles of a fluorine-based polymer weight body).

The amount of the external additive is preferably from 0.01% by mass to 5% by mass and more preferably from 0.01% by mass to 2.0% by mass with respect to toner particles.

(Method of Producing Toner)

Next, a method of producing a toner according to the exemplary embodiment will be described.

The toner according to the exemplary embodiment can be obtained by adding an external additive to toner particles after the toner particles are produced.

The toner particles may be produced using any one of a dry method (for example, a kneading and pulverizing method) or a wet method (for example, an aggregation and coalescence method, a suspension polymerization method, or a dissolution suspension method). The method of producing toner particles is not particularly limited, and a known method is employed.

Among these, the toner particles may be obtained using an aggregation and coalescence method.

Further, the toner according to the exemplary embodiment is produced by adding an external additive to the obtained toner particles in a dry state and mixing the mixture. The mixing may be performed using a V blender, a HENSHEL mixer, or a RODIGE mixer. Further, coarse particles of the toner may be removed using a vibration sieve or an air sieve if necessary.

In addition, a mixing ratio (mass ratio) of the toner to the carrier in the developer according to the exemplary embodiment is preferably from 1:100 to 30:100 and more preferably from 3:100 to 20:100.

<Image Forming Apparatus/Image Forming Method>

The image forming apparatus and the image forming method according to the exemplary embodiment will be described.

The image forming apparatus according to the exemplary embodiment includes an image holding member; a charging unit that charges the surface of the image holding member; an electrostatic image forming unit that forms an electrostatic image on the surface of the charged image holding member; a developing unit that accommodates an electrostatic image developer and develops the electrostatic image formed on the surface of the image holding member as a toner image using the electrostatic image developer; a transfer unit that transfers the toner image formed on the surface of the image holding member to the surface of a recording medium; and a fixing unit that fixes the toner image transferred to the surface of the recording medium.

In addition, the electrostatic image developer according to the exemplary embodiment is applied as an electrostatic image developer.

In the image forming apparatus according to the exemplary embodiment, the image forming method according to the exemplary embodiment is performed as an image forming method (image forming method according to the exemplary embodiment) including a charging process of charging the surface of the image holding member; an electrostatic image forming process of forming an electrostatic image on the surface of the charged image holding member; a developing process of developing the electrostatic image formed on the surface of the image holding member as a toner image using the electrostatic image developer according to the exemplary embodiment; a transfer process of transferring the toner image formed on the surface of the image holding member to the surface of a recording medium; and a fixing process of fixing the toner image transferred to the surface of the recording medium.

Examples of the image forming apparatus according to the exemplary embodiment include known image forming apparatuses such as an apparatus having a direct transfer system of directly transferring a toner image formed on a surface of an image holding member to a recording medium; an apparatus having an intermediate transfer system of primarily transferring a toner image formed on a surface of an image holding member to a surface of an intermediate transfer body and then secondarily transferring the toner image transferred to the surface of the intermediate transfer body to a surface of a recording medium; an apparatus including a cleaning unit that performs cleaning of a surface of an image holding member before charging and after transferring a toner image; and an apparatus including a charge removing unit that removes the charge by irradiating a surface of an image holding member with charge-removed light before charging and after transferring a toner image.

In the case of the apparatus having an intermediate transfer system, the transfer unit has a configuration including an intermediate transfer body in which a toner image is transferred to a surface; a primary transfer unit that primarily transfers the toner image formed on a surface of an image holding member to the surface of the intermediate transfer body; and a secondary transfer unit that secondarily transfers the toner image transferred to the surface of the intermediate transfer body to the surface of the recording medium.

In addition, in the image forming apparatus according to the exemplary embodiment, a portion including the developing unit may have a cartridge structure (process cartridge) which is detachably attached to the image forming apparatus. As the process cartridge, a process cartridge accommodating the electrostatic image developer according to the exemplary embodiment and including the developing unit is preferably used.

Hereinafter, an example of the image forming apparatus according to the exemplary embodiment will be described, but the present invention is not limited thereto. In addition, main elements illustrated in the figures are described and description of other elements is omitted.

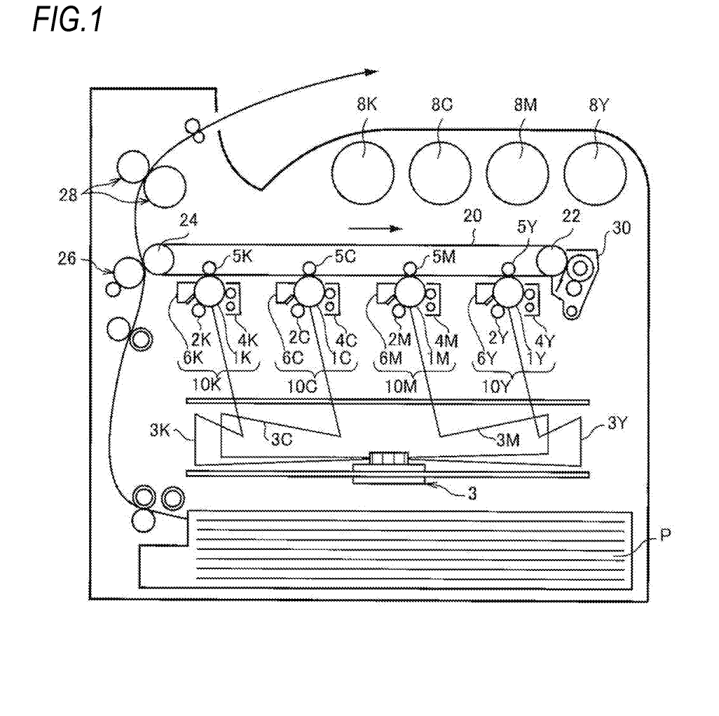

FIG. 1 is a view schematically illustrating the configuration of the image forming apparatus according to the exemplary embodiment.

The image forming apparatus illustrated in FIG. 1 includes first to fourth image forming units 10Y, 10M, 10C, and 10K (image forming units) having an electrophotographic system of outputting images of respective colors of yellow (Y), magenta (M), cyan (C), and black (K) based on color-separated image data. These image forming units (hereinafter, simply referred to as “units” in some cases) 10Y, 10M, 10C, and 10K are disposed in parallel in a state of being separated from one another by a predetermined distance in the horizontal direction. Further, these units 10Y, 10M, 10C, and 10K may be process cartridges that are detachably attached to the image forming apparatus.

On the upper side in the figure of respective units 10Y, 10M, 10C, and 10K, an intermediate transfer belt 20 is extended as an intermediate transfer body through the respective units. The intermediate transfer belt 20 is provided in a state of winding a driving roll 22 and a support roll 24 in contact with the inner surface of the intermediate transfer belt 20 which are arranged by being separated from each other from the left to the right direction of the figure, and travels toward the fourth unit 10K from the first unit 10Y. Moreover, in the support roll 24, a force is applied to a direction away from the driving roll 22 due to a spring or the like (not illustrated) and tension is applied to the intermediate transfer belt 20 wound around the support roll and the driving roll. Further, an intermediate transfer body cleaning apparatus 30 is provided on the side surface of the image holding member of the intermediate transfer belt 20 so as to face the driving roll 22.

In addition, four toner colors, yellow, magenta, cyan, and black accommodated in toner cartridges 8Y, 8M, 8C, and 8K are supplied to respective developing devices (developing units) 4Y, 4M, 4C, and 4K of the respective units 10Y, 10M, 10C, and 10K.

Since the first to fourth units 10′Y, 10M, 10C, and 10K have the same configuration, the first unit 10Y which is disposed on the upstream side of the intermediate transfer belt in a travelling direction and forms a yellow image will be described as a representative example. In addition, the description of the second to fourth units 10M, 10C, and 10K is omitted by denoting the reference numeral of magenta (M), cyan (C), or black (K) to a part equivalent to the first unit 10Y instead of yellow (Y).

The first unit 10Y includes a photoreceptor 1Y which is operated as an image holding member. A charging roll (an example of a charging unit) 2Y that charges the surface of the photoreceptor 1Y to a predetermined potential; an exposure device (an example of an electrostatic image forming unit) 3 that forms an electrostatic image by exposing the charged surface with laser light 3Y based on a color-separated image signal; a developing device (an example of a developing unit) 4Y that develops the electrostatic image by supplying a charged toner to the electrostatic image; a primary transfer roll 5Y (an example of a primary transfer unit) that transfers a developed toner image onto the intermediate transfer belt 20; and a photoreceptor cleaning device (an example of a cleaning unit) 6Y that removes a toner remaining on the surface of the photoreceptor 1Y after the primary transfer is done are arranged around the photoreceptor 1Y in this order.

In addition, the primary transfer roll 5Y is arranged in the inside of the intermediate transfer belt 20 and provided in a position facing the photoreceptor 1. Further, bias power sources (not illustrated) applying primary transfer bias are respectively connected to each of the primary transfer rolls 5Y, 5M, 5C, and 5K. The respective bias power sources change the transfer bias applied to the respective primary transfer rolls through control of a control unit (not illustrated).

Hereinafter, an operation of forming a yellow image in the first unit 10Y will be described.

First, prior to the operation, the surface of the photoreceptor 1Y is charged to a potential of −600 V to −800 V by the charging roll 2Y.

The photoreceptor 1Y is formed by laminating a photosensitive layer on a conductive (for example, volume resistivity at 20° C.: 1×10⁻⁶ Ω·cm or less) substrate. The photosensitive layer has high resistance (resistant to a normal resin) in general, but the photosensitive layer has a property in which specific resistance of a portion irradiated with laser light is changed when the portion is irradiated with laser light 3Y. For this reason, the layer light 3Y is output to the surface of the charged photoreceptor 1Y through the exposure device 3 according to image data for yellow transmitted from the control unit (not illustrated). The photosensitive layer on the surface of the photoreceptor 1Y is irradiated with the laser light 3Y, and accordingly, an electrostatic image of a yellow image pattern is formed on the surface of the photoreceptor 1Y.

The electrostatic image is an image formed on the surface of the photoreceptor 1Y through charging and is a so-called negative latent image formed when the specific resistance on the portion of the photosensitive layer being irradiated with the laser light 3Y is decreased, the charged charge of the surface of the photoreceptor 1Y flows, and the charge of the portion not irradiated with the laser light 3Y remains.

The electrostatic image formed on the photoreceptor 1Y is rotated to a predetermined developing position according to travelling of the photoreceptor 1Y. In addition, the electrostatic image on the photoreceptor 1Y is made into a visible image (developed image) as a toner image by the developing device 4Y in the developing position.

For example, an electrostatic image developer including at least a yellow toner and a carrier according to the exemplary embodiment is accommodated in the developing device 4Y. The yellow toner is frictionally charged by being stirred in the inside of the developing device 4Y and is held on a developer roll (an example of a developer holding member) with a charge of the same polarity (negative polarity) as the charge charged on the photoreceptor 1Y. Further, when the surface of the photoreceptor 1Y passes through the developing device 4Y, the yellow toner is electrostatically adhered to a charge-removed latent image portion on the surface of the photoreceptor 1Y and a latent image is developed by the yellow toner. The photoreceptor 1Y on which a yellow toner image is formed continuously travels at a predetermined speed and the toner image developed on the photoreceptor 1Y is conveyed to a predetermined primary transfer position.

When the yellow toner image on the photoreceptor 1Y is conveyed to the primary transfer position, primary transfer bias is applied to the primary transfer roll 5Y, the electrostatic force toward the primary transfer roll 5Y from the photoreceptor 1Y acts on the toner image, and the toner image on the photoreceptor 1Y is transferred onto the intermediate transfer belt 20. The transfer bias to be applied at this time is a positive (+) polarity which is an opposite polarity of the toner polarity (−) and is controlled to be +10 μA by a control unit (not illustrated) in the first unit 10Y. In addition, a toner remaining on the photoreceptor 1Y is removed by the photoreceptor cleaning device 6Y to be collected.

In addition, the primary transfer bias to be applied to primary transfer rolls 5M, 5C, and 5K subsequent to the second unit 10M is controlled by the first unit.

In this manner, the intermediate transfer belt 20 to which a yellow toner image is transferred in the first unit 10Y is sequentially conveyed through the second to fourth units 10M, 10C, and 10K, and multiple toner images of respective colors, which are overlapped with each other, are transferred.

The intermediate transfer belt 20 to which four colors of multiple toner images are transferred by passing through the first to fourth units reaches the secondary transfer unit formed of the intermediate transfer belt 20, the support roll 24 in contact with the inner surface of the intermediate transfer belt, and a secondary transfer roll (an example of a secondary transfer unit) 26 arranged on the image holding surface side of the intermediate transfer belt 20. In addition, the recording paper (an example of a recording medium) P is fed to a void in contact with the secondary transfer roll 26 and the intermediate transfer belt 20 through a supply mechanism at a predetermined timing, and the secondary transfer bias is applied to the support roll 24. The transfer bias to be applied in this manner is the negative (−) polarity which is the same as the polarity (−) of a toner, the electrostatic force toward the recording paper P from the intermediate transfer belt 20 acts on the toner image, and the toner image on the intermediate transfer belt 20 is transferred onto the recording paper P. Further, the secondary transfer bias at this time is determined according to the resistance detected by a resistance detecting unit (not illustrated) that detects the resistance of the secondary transfer unit and the voltage thereof is controlled.

Next, the recording paper P is sent to a pressure-contact unit (nip portion) of a pair of fixing rolls in a fixing device (an example of a fixing unit) 28, the toner image is fixed onto the recording paper P, and a fixed image is formed.

As the recording paper P transferring a toner image, plain paper used in a copying machine having an electrophotographic system or a printer can be exemplified. As the recording medium, an OHP sheet can be exemplified in addition to the recording paper P. In order to improve smoothness of the surface of the fixed image, the surface of the recording paper P is also preferably smooth, and coated paper obtained by coating the surface of plain paper with a resin or the like or art paper for printing is preferably used.

The recording paper P in which fixation of a color image is completed is conveyed toward a discharge unit and a series of color image forming operations are completed.

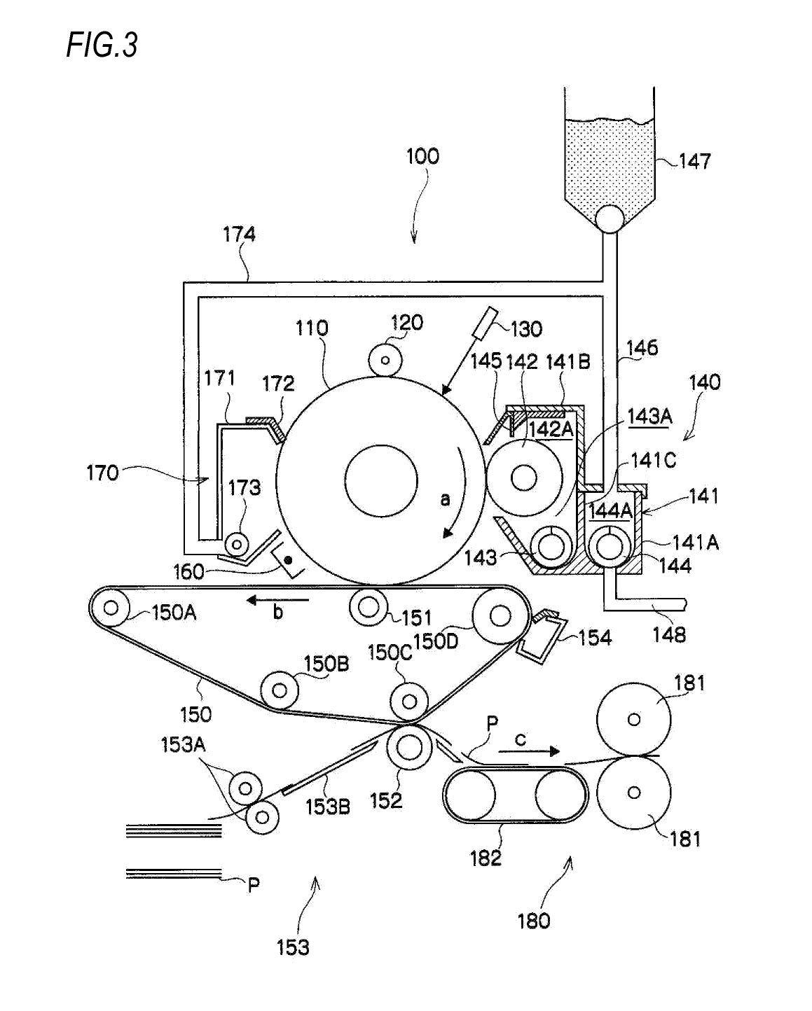

Further, FIG. 3 is a view schematically illustrating an example of a basic configuration of the image forming apparatus according to the present exemplary embodiment. The image forming apparatus illustrated in FIG. 3 has a configuration to which a reclaim system of collecting the residual toner remaining on the surface of an image holding member with a cleaning unit and reusing the residual toner by returning the residual toner to a developing unit is employed. Further, the image forming apparatus illustrated in FIG. 3 has a configuration to which a trickle developing type of supplying the developer according to the exemplary embodiment to a developer container in the developing unit using a developer supply unit and discharging at least some of the developer accommodated in the developer container using a developer discharge unit is employed.

An image forming apparatus 100 includes an image holding member 110 that rotates in the clockwise direction indicated by an arrow a in FIG. 3; a charging unit 120 that is provided relative to the image holding member 110 on the upper side of the image holding member 110 and negatively charges the surface of the image holding member 110; an electrostatic latent image forming unit 130 that forms an electrostatic latent image by writing an image to be formed by a developer (toner) on the surface of the image holding member 110 charged by the charging unit 120; a developing unit 140 that is provided on the downstream side of the electrostatic latent image forming unit 130 and forms a toner image on the surface of the image holding member 110 by allowing the toner to be attached to the electrostatic latent image formed by the electrostatic latent image forming unit 130; an endless intermediate transfer belt 150 that contacts with the image holding member 110, scans in a direction indicated by an arrow b, and transfers the toner image formed on the surface of the image holding member 110; a charge removing unit 160 that removes the charge of the surface of the image holding member 110 after the toner image is transferred to the intermediate transfer belt 150 and makes residual toner remaining on the surface thereof easy to be removed; a cleaning unit 170 that removes the residual toner on the surface of the image holding member 110 serving as a residual toner collecting unit and collects the residual toner; and a residual toner conveying unit 174 that coveys the residual toner, which is removed by the cleaning unit 170 and then collected, and supplies the residual toner to the developing unit 140.

The charging unit 120, the electrostatic latent image forming unit 130, the developing unit 140, the intermediate transfer belt 150, the charge removing unit 160, and the cleaning unit 170 are arranged on the circumference surrounding the image holding member 110 in the clockwise direction.

The intermediate transfer belt 150 is maintained in a state in which tensile strength is applied by support rollers 150A and 150B, a rear roller 150C, and a driving roller 150D from the inside and is driven in the direction of an arrow b according to rotation of the driving roller 150D. A primary transfer roller 151 that positively charges the intermediate transfer belt 150 and allows the toner on the image holding member 110 to be adsorbed to the surface on the outside of the intermediate transfer belt 150 is provided in a position relative to the image holding member 110 on the inside of the intermediate transfer belt 150. A secondary transfer roller 152 that transfers the toner image formed on the intermediate transfer belt 150 onto a recording medium P by positively charging the recording medium P and pressing the recording medium P to the intermediate transfer belt 150 is provided so as to face the rear roller 150C on the outside and the lower side of the intermediate transfer belt 150.

A recording medium supply device 153 that supplies the recording medium P to the secondary transfer roller 152 and a fixing unit 180 that conveys the recording medium P with a toner image formed in the secondary transfer roller 152 and fixes the toner image are further provided on the lower side of the intermediate transfer belt 150.

The recording medium supply device 153 includes a pair of conveying rollers 153A and a guiding slope 153B that guides the recording medium P conveyed by the conveying rollers 153A toward the secondary transfer roller 152. In addition, the fixing unit 180 includes fixing rollers 181 which are a pair of heat rollers performing fixation of the toner image by heating and pressing the recording medium P in which the toner image is transferred by the secondary transfer roller 152, and a conveying conveyor 182 that conveys the recording medium toward the fixing roller 181.

The recording medium P is conveyed by the recording medium supply device 153, the secondary transfer roller 152, and the fixing unit 180 in a direction indicated by an arrow c.

An intermediate transfer member cleaning unit 154 that includes a cleaning blade transferring a toner image to the recording medium P in the secondary transfer roller 152 and then removing a toner remaining on the intermediate transfer belt 150 is provided so as to be arranged on the opposite side of the driving roller 150D in a state of interposing the intermediate transfer belt 150 therebetween.

Hereinafter, the developing unit 140 will be described in detail. The developing unit 140 is arranged so as to face the image holding member 110 in a development area and includes a developer container 141 that accommodates a two-component developer including a toner charged to a negative (−) polarity and a carrier charged to a positive (+) polarity. The developer container 141 includes a developer container body 141A and a developer container cover 141B that covers the upper end thereof.

The developer container body 141A includes a developing roll chamber 142A that accommodates the developing roll 142 in the inside thereof; and a first stirring chamber 143A and a second stirring chamber 144A that is adjacent to the first stirring chamber 143A which are adjacent to the developing roll chamber 142A. Further, a layer thickness regulating member 145 for regulating the layer thickness of a developer on the surface of the developing roll 142 at the time when the developer container cover 141B is mounted on the developer container body 141A is provided in the developing roll chamber 142A.

The first stirring chamber 143A and the second stirring chamber 144A are partitioned by a partition wall 141C and the first stirring chamber 143A and the second stirring chamber 144A communicate with each other in both end portions of the partition wall 141C in the longitudinal direction (longitudinal direction of the developing device) (not illustrated). In this manner, a circulation stirring chamber (143A+144A) is formed of the first stirring chamber 143A and the second chamber 144A.

Further, the developing roll 142 is arranged in the developing roll chamber 142A so as to face the image holding member 110. The developing roll 142 is provided with a sleeve on the outside of a magnetic roll (fixed magnet) having magnetism (not illustrated). The developer of the first stirring chamber 143A is adsorbed to the surface of the developing roll 142 by the magnetic force of the magnetic roll and conveyed to the development area. Further, a roll axis of the developing roll 142 is rotatably supported by the developer container body 141A. Here, the developing roll 142 and the image holding member 110 rotate in opposite directions to each other, and the developer adsorbed to the surface of the developing roll 142 is conveyed to the development area from a direction which is the same as the travelling direction of the image holing member 110 in a facing portion.

Further, a bias power source (not illustrated) is connected to the sleeve of the developing roll 142 and the predetermined developing bias is applied thereto (in the present exemplary embodiment, the bias in which an alternating current (AC) component is superimposed on a direct current (DC) component is applied such that an alternating electric field is applied to a development area).

A first stirring member 143 (stirring and conveying member) and a second stirring member 144 (stirring and conveying member) that convey a developer while stirring the developer are arranged in the first stirring chamber 143A and the second stirring chamber 144A. The first stirring member 143 includes a first rotary axis that extends the axis direction of the developing roll 142 and a stirring and conveying blade (projection) which is spirally fixed to the outer circumference of the rotary axis. In the same manner, the second stirring member 144 includes a second rotary axis and a stirring and conveying blade (projection). Further, the stirring member is rotatably supported by the developer container body 141A. In addition, the first stirring member 143 and the second stirring member 144 are arranged such that the developers in the first stirring chamber 143A and the second stirring chamber 144A are conveyed by the rotation thereof in the opposite directions to each other.

An end of a developer supply unit 146 for supplying a developer for replenishment including a toner for replenishment and a carrier for supply to the second stirring chamber 144A is connected to one end side of the second stirring chamber 144A in the longitudinal direction, and a developer cartridge 147 accommodating a developer for replenishment is connected to another end of the developer supply unit 146. Moreover, one end of a developer discharge unit 148 for discharging the accommodated developer is connected to one end side of the second stirring chamber 144A in the longitudinal direction and a developer collecting container collecting the discharged developer (not illustrated) is connected to another end of the developer discharge unit 148.

The developing unit 140 employs a so-called trickle developing type in which a developer for replenishment is supplied from the developer cartridge 147 to the developing unit (second stirring chamber 144A) 140 through the developer supply unit 146 and a deteriorated developer is discharged from the developer discharge unit 148. The trickle developing type is a developing type in which development is performed by gradually supplying a developer for replenishment (trickle developer) to the developing device and discharging a deteriorated developer which becomes excessive (largely including a deteriorated carrier) in order to extend the period for replacing the developer by suppressing deterioration of the charging performance of the developer.

In the present exemplary embodiment, an example of a configuration in which the developer cartridge 147 accommodating a developer for replenishment which includes the carrier of the present exemplary embodiment is used is described, but the developer cartridge 147 may have a configuration in which a cartridge accommodating only a toner for replenishment is separated from a cartridge accommodating only the carrier of the present exemplary embodiment or a configuration which does not have the trickle developing type and in which a toner cartridge accommodating only a toner for replenishment is included.

Next, the cleaning unit 170 will be described in detail. The cleaning unit 170 includes a housing 171 and a cleaning blade 172 arranged so as to project from the housing 171. The cleaning blade 172 is a plate-like blade extending in the axial direction of the rotary axis of the image holding member 110 and the tip portion (edge portion) thereof contacts with the downstream side further than the transfer position by the primary transfer roller 151 in the transfer direction (direction indicated by an arrow a) in the image holding member 110 and the downstream side in the transfer direction further than the position from which the charge is removed by the charge removing unit 160.

The cleaning blade 172 removes foreign materials, such as residual toner attached to the image holding member 110 which is not transferred to the intermediate transfer belt 150 by the primary transfer roller 151, through rotation of the image holding member 110 in the direction indicated by an arrow a by damming from the image holding member 110.

The transfer member 173 is arranged on the bottom portion in the housing 171 and one end of the residual toner conveying unit 174 for conveying residual toner (developer) which is removed by the cleaning bladed 172 and then collected and supplying the residual toner to the developing unit 140 is connected to the downstream side of the conveying member 173 in the conveying direction in the housing 171. Further, another end of the residual toner conveying unit 174 is connected so as to join with the developer supply unit 146.

In this manner, the cleaning unit 170 conveys the residual toner through the residual toner conveying unit 174 to the developing unit 140 (second stirring chamber 144A) according to the rotation of the conveying member 173 provided in the bottom portion of the housing 171, and the residual toner collected from the surface of the image holding member 110 is stirred and conveyed with a developer (toner) accommodated in the developing unit 140 and then reused.

In addition, in the image forming apparatus having the reclaim system according to the exemplary embodiment, a portion including a developing unit may have a cartridge structure (process cartridge) which is detachably attached with respect to the image forming apparatus. For example, a process cartridge which is detachably attached to the image forming apparatus including a developing unit that accommodates an electrostatic image developer according to the exemplary embodiment and develops the electrostatic image formed on the surface of the image holding member as a toner image by the electrostatic image developer; a residual toner collecting unit that collects the residual toner remaining on the surface of the image holding member; and a residual toner conveying unit that conveys the collected residual toner and supplies the residual toner to the developing unit is preferably used.

<Process Cartridge/Developer Cartridge>

A process cartridge according to the exemplary embodiment will be described.

The process cartridge according to the exemplary embodiment is a process cartridge that accommodates the electrostatic image developer according to the exemplary embodiment, includes a developing unit developing an electrostatic image formed on the surface of the image holding member as a toner image by the electrostatic image developer, and is detachably attached to the image forming apparatus.

In addition, the process cartridge according to the exemplary embodiment may have a configuration, which is not limited to the above-described configuration, including a developing device and at least one unit selected from other units of an image holding member, a charging unit, an electrostatic image forming unit, and a transfer unit according to the necessity.

Hereinafter, an example of the process cartridge according to the exemplary embodiment will be described, but the present invention is not limited thereto. In addition, main elements illustrated in the figures are described and description of other elements is omitted.

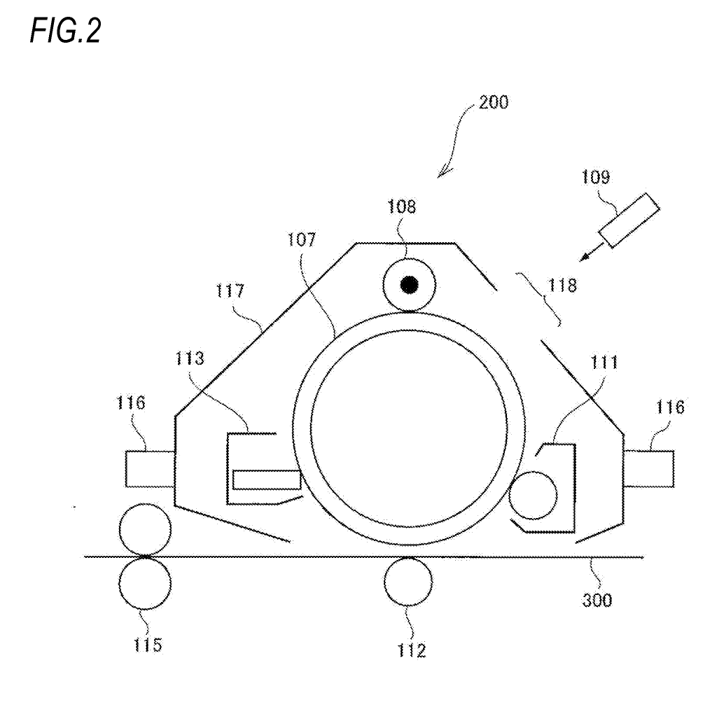

FIG. 2 is a view schematically illustrating the configuration of the process cartridge according to the exemplary embodiment.

A process cartridge 200 illustrated in FIG. 2 is configured by integrally combining and holding a photoreceptor 107 (an example of an image holding member), a charging roll 108 (an example of a charging unit) provided in the vicinity of the photoreceptor 107, a developing device 111 (an example of a developing unit), and a photoreceptor cleaning device 113 (an example of a cleaning unit) by a housing 117 including a mounting rail 116 and an opening portion 118 for exposure and made into a cartridge.

Further, in FIG. 2, the reference numeral 109 indicates an exposure device (an example of an electrostatic image forming unit), the reference numeral 112 indicates a transfer device (an example of a transfer unit), the reference numeral 115 indicates a fixing device (an example of a fixing unit), and the reference numeral 300 indicates recording paper (an example of a recording medium).

Next, a developer cartridge according to the exemplary embodiment will be described.

The developer cartridge according to the exemplary embodiment is a developer cartridge that accommodates the developer according to the exemplary embodiment and is detachably attached to the image forming apparatus.

The carrier according to the exemplary embodiment can be preferably used as a carrier for developing with a so-called trickle type that performs developing while the carrier accommodated in a developing unit is replaced. For example, the image forming apparatus illustrated in FIG. 1 may be an image forming apparatus of a trickle type that performs developing while the carrier for developing an electrostatic image accommodated in developing devices 4Y, 4M, 4C, and 4K is replaced by setting toner cartridges 8Y, 8M, 8C, and 8K as the developer cartridges according to the exemplary embodiment and replenishing the developing devices 4Y, 4M, 4C, and 4K with a developer.

Since variation of the amount of the carrier to replenish the developing device becomes large as the amount of the carrier becomes large, the amount of the carrier according to the exemplary embodiment in the developer included in the developer cartridge is preferably 20% by mass or less of the amount of the toner and more preferably from 1% by mass to 10% by mass.

Further, a cartridge accommodating a toner for replenishment alone may be different from a cartridge accommodating the carrier according to the exemplary embodiment alone.

### EXAMPLE

Hereinafter, the present exemplary embodiment will be described in detail based on Examples and Comparative Examples, but the invention is not limited to Examples below.

Further, “parts” indicates “parts by mass” unless otherwise noted.

[Preparation of Toner 1]

(Coloring Agent Dispersion Liquid 1)

Cyan pigment: copper phthalocyanine C. I. Pigment Blue 15:3 (manufactured by Dainichiseika Color & Chemicals Mfg. Co., Ltd.): 50 parts by mass

Anionic surfactant: NEOGEN SC (manufactured by Dai-ichi Kogyo Seiyaku Co., Ltd.): 5 parts by mass

Ion exchange water: 200 parts by mass

The above-described components are mixed, dispersed by ULTRA-TURRAX (manufactured by IKA, Inc.) for 5 minutes, and further dispersed by an ultrasonic bath for 10 minutes, thereby obtaining a coloring agent dispersion liquid 1 having a solid content of 21% by mass. When the volume average particle diameter is measured using a particle size measuring instrument LA-700 (manufactured by Horiba, Ltd.), the value is 160 nm.

(Release Agent Dispersion Liquid 1)

Paraffin wax: HNP-9 (manufactured by Nippon Seiro Co., Ltd.): 19 parts by mass

Anionic surfactant: NEOGEN SC (manufactured by Dai-ichi Kogyo Seiyaku Co., Ltd.): 1 part by mass

Ion exchange water: 80 parts by mass

The above-described components are mixed in a heat-resistant container and stirred for 30 minutes by increasing the temperature therein to 90° C. Next, the melt from the bottom portion of the container is circulated to a Gaulin homogenizer, a circulation operation corresponding to three passes is performed under the condition of a pressure of 5 MPa, the pressure is increased to 35 MPa, and then the circulation operation corresponding to three passes is further performed. The temperature of an emulsified liquid obtained in this manner is cooled to lower than or equal to 40° C. in the heat-resistant container, thereby obtaining a release agent dispersion liquid 1. When the volume average particle diameter is measured using a particle size measuring instrument LA-700 (manufactured by Horiba, Ltd.), the value is 240 nm.

(Resin Particle Dispersion Liquid 1)

—Oil Layer—

Styrene (manufactured by Wako Pure Chemical Industries, Ltd.): 30 parts by mass

Acrylic acid n-butyl (manufactured by Wako Pure Chemical Industries, Ltd.): 10 parts by mass

β-carboxyethyl acrylate (manufactured by Rhodia Nikka, Ltd.): 1.3 parts by mass

Dodecane thiol (manufactured by Wako Pure Chemical Industries, Ltd.): 0.4 parts by mass

—Water layer 1—

Ion exchange water: 17 parts by mass

Anionic surfactant (DAWFAX, manufactured by Dow Chemical Company): 0.4 parts by mass

Water Layer 2—

Ion exchange water: 40 parts by mass

Anionic surfactant (DAWFAX, manufactured by Dow Chemical Company): 0.05 parts by mass

Ammonium peroxodisulfate (manufactured by Wako Pure Chemical Industries, Ltd.): 0.4 parts by mass

The components of the oil layer and the components of the water layer 1 are put into a flask and stirred and mixed with each other to be set as a monomer emulsified dispersion liquid. The components of the water layer 2 are put into a reaction container, the inside of the container is sufficiently substituted with nitrogen, and the reaction system is heated to 75° C. using an oil bath while stirring. The above-described monomer emulsified dispersion liquid is gradually added dropwise to the reaction container for 3 hours, and emulsion polymerization is performed. Polymerization is further continued at 75° C. after dropwise addition and then completed after 3 hours.

When the volume average particle diameter D50v of the obtained resin particles is measured using a laser diffraction particle size distribution measuring device LA-700 (manufactured by Horiba, Ltd.), the value is 250 nm. Further, when the glass transition temperature of a resin at a temperature rising rate of 10° C./min is measured using a differential scanning calorimeter (DSC-50, manufactured by Shimadzu Corporation), the temperature is 53° C. Further, when the number average molecular weight (in terms of polystyrene) is measured by a molecular weight measuring instrument (HLC-8020, manufactured by Tosoh Corporation) using THF as a solvent, the value is 13000. In this manner, a resin particle dispersion liquid 1 having a volume average particle diameter of 250 nm, a solid content of 42% by mass, a glass transition temperature of 52° C., and a number average molecular weight Mn of 13000 is obtained.

(Preparation of Toner 1)

Resin particle dispersion liquid 1: 150 parts by mass

Coloring agent particle dispersion liquid 1: 30 parts by mass

Release agent dispersion liquid 1: 40 parts by mass

Polyaluminum chloride: 0.4 parts by mass

The above-described components are mixed and dispersed using ULTRA-TURRAX (manufactured by IKA, Inc.) in a stainless steel flask, and heated to 48° C. while the components in the flask are stirred with an oil bath for heating. The mixture is held at 48° C. for 80 minutes and 70 parts by mass of the resin particle dispersion liquid 1 is gradually added thereto.

Next, the pH in the system is adjusted to 6.0 using an aqueous sodium hydroxide solution having a concentration of 0.5 mol/L, the stainless steel flask is sealed, a seal of a stirring shaft is magnetically sealed, the flask is heated to 97° C. while stirring is continued, and then the flask is held for 3 hours. After the reaction is completed, the resultant is cooled at a cooling rate of 1° C./min, filtered, sufficiently washed with ion exchange water and solid-liquid separation is performed by Nutsche suction filtration. The resultant is re-dispersed using 3 L of ion exchange water at 40° C., stirred at 300 rpm for 15 minutes, and then washed. The washing operation is repeatedly performed 5 times and solid-liquid separation is performed by Nutsche suction filtration using filter paper No. 5A when the pH of the filtrate becomes 6.54 and the electric conductivity becomes 6.5 μS/cm. Next, vacuum drying is continued for 12 hours and toner particles are obtained.

When the volume average particle diameter D50v of the toner particles is measured using a coulter counter, the value is 6.2 μm and the volume average particle size distribution index GSDv is 1.20. When the shape thereof is observed using a LUZEX image analyzer (manufactured by Luzex, Inc.), the shape factor SF1 of the particles is 135 and the shape thereof is a potato.

The glass transition temperature of the toner particles is 52° C.

In addition, silica (SiO₂) particles which are subjected to a surface hydrophobic treatment using hexamethyldisilazane (hereinafter, referred to as “HMDS” in some cases) and have a primary particle average particle diameter of 40 nm and metatitanic acid compound particles which are reaction products obtained by reacting metatitanic acid and isobutyltrimethoxysilane and have a primary particle average particle diameter of 20 nm are added to the toner particles such that the coating rate with respect to the surface of the toner particles becomes 40%, and the mixture is mixed with a Henschel mixer, thereby preparing a toner 1.

(Preparation of Coating Liquid 1)

Cyclohexyl methacrylate resin (weight average molecular weight: 50000): 36 parts by mass

Carbon black VXC72 (manufactured by Cabot Corporation): 4 parts by mass

Toluene: 250 parts by mass

Isopropyl alcohol: 50 parts by mass

The above-described components and glass beads (particle diameter: 1 mm) with the same amount as that of toluene are put into a sand mill (manufactured by Kansai Paint Co., Ltd.), and the mixture is stirred at a rotation speed of 1200 rpm for 30 minutes, thereby preparing a coating liquid 1 having a solid content of 11% by mass.

(Preparation of Coating Liquid 2)

Methylmethacrylate resin (weight average molecular weight: 70000): 36 parts by mass

Carbon black VXC72 (manufactured by Cabot Corporation): 4 parts by mass

Toluene: 250 parts by mass

Isopropyl alcohol: 50 parts by mass

The above-described components and glass beads (particle diameter lmm) with the same amount as that of toluene are put into a sand mill (manufactured by Kansai Paint Co., Ltd.), and the mixture is stirred at a rotation speed of 1200 rpm for 30 minutes, thereby preparing a coating liquid 2 having a solid content of 11% by mass.

(Preparation of Magnetic Particles 1)

1597 parts by mass of Fe₂O₃, 890 parts by mass of Mn(OH)₂, and the silica content in which silica is contained in the above-described compound are mixed with one another so as to be 25 parts by mass, and 6.6 parts by mass of polyvinyl alcohol is further added thereto, and then a dispersant, water, and zirconia beads having a media diameter of 1 mm are added thereto and the mixture is crushed and mixed in a sand mill. Next, the mixture is granulated and dried such that the diameter of particles dried with a spray drier becomes 38 μm.

Further, the resultant is heated in an electric furnace at 1000° C. for 6 hours, heated at 1400° C. for 2 hours, and then heated for 8 hours after the temperature thereof is decreased to 800° C. in an oxygen-nitrogen-mixed atmosphere having an oxygen concentration of 1%.

Magnetic particles (ferrite particles) 1 are obtained after the obtained particles are subjected to the crushing process and the classifying process. The volume average particle diameter of the magnetic particles 1 is 35 μm.

In addition, the resistance (high humidity resistance) under an electric field of 19200 V/cm in an environment of a temperature of 30° C. and a relative humidity of 85% is 7.5 log Ωcm and the resistance (low humidity resistance) under an electric field of 19200 V/cm in an environment of a temperature of 10° C. and a relative humidity of 15% is 8.01 log Ωcm, and the ratio thereof is 1.07.

Further, the flow rate of the magnetic particles 1 is 28 sec/50 g.

Further, the particle diameters of the magnetic particles and pulverized particles, the resistance of the magnetic particles, and the flow rate of the magnetic particles are respectively measured using a method described below.

Particle Diameter of Particles

The volume average particle diameters of the magnetic particles and pulverized particles are measured using a laser diffraction particle size distribution measuring device (LA-700 (manufactured by Horiba, Ltd.). The particle diameter corresponding to 50% accumulation is set as the volume average particle diameter measured by drawing cumulative distribution of the volume from the small diameter side with respect to the divided particle size range (channel) based on the obtained particle size distribution.

Measurement of Resistance

Two sheets of polar plates are allowed to face each other in parallel with a width of 1 mm, 0.25 g of magnetic particles are put therebetween, the magnetic particles are held using a magnet with a cross-sectional area of 2.4 cm², 800 V of an applied voltage is applied thereto, and then the current value is measured. The electric field at the time is 19200 V/cm. The resistance value is calculated from the obtained current value.

Flow Rate

The flow rate of the magnetic particles is measured in conformity with JIS-Z 2502:2012.

(Preparation of Magnetic Particles 2 to 9)

Magnetic particles 2 to 9 are prepared in the same manner as that of the magnetic particles 1 except that the conditions when the magnetic particles 1 are prepared are changed as listed in Table 1, and the particle diameters of the magnetic particles and pulverized particles, the resistance of the magnetic particles, and the flow rate of the magnetic particles are measured.

The configurations and the physical properties of the magnetic particles 1 to 9 are listed in Table 1. Further, the high humidity resistance and the low humidity resistance respectively are noted as values of common logarithm.

TABLE 1

| | Physical properties | | | | | | | | |
|---|---|---|---|---|---|---|---|---|---|
| | | High | Low | | | | | | |
| | | humidity | humidity | | | | | | |
| | Resistance | resistance | resistance | Flow rate | Composition ratio | | | | |
| | ratio | (logΩcm) | (logΩcm) | (sec/50 g) | Fe₂O₃ | Mn(OH)₂ | SiO₂ | CaCO₃ | Li₂O |
| Magnetic | 1.07 | 7.5 | 8.0 | 28 | 1597 | 890 | 25 | 0 | 0 |
| particles 1 | | | | | | | | | |
| Magnetic | 1.02 | 8.3 | 8.5 | 27 | 1597 | 890 | 20 | 30 | 0 |
| particles 2 | | | | | | | | | |
| Magnetic | 1.14 | 7.0 | 8.0 | 29 | 1597 | 890 | 30 | 0 | 0 |
| particles 3 | | | | | | | | | |
| Magnetic | 1.05 | 7.4 | 7.8 | 25 | 1597 | 890 | 20 | 35 | 0 |
| particles 4 | | | | | | | | | |
| Magnetic | 1.12 | 8.0 | 9.0 | 30 | 1597 | 890 | 32 | 0 | 0 |
| particles 5 | | | | | | | | | |
| Magnetic | 1.17 | 8.5 | 10 | 29 | 1597 | 890 | 30 | 15 | 0 |
| particles 6 | | | | | | | | | |
| Magnetic | 1.12 | 6.5 | 7.3 | 22 | 1597 | 450 | 0 | 0 | 180 |
| particles 7 | | | | | | | | | |
| Magnetic | 1.04 | 5.5 | 5.7 | 33 | 1597 | 890 | 0 | 0 | 0 |
| particles 8 | | | | | | | | | |
| Magnetic | >1.15 | Impossible | 6.0 | 30 | 1597 | 890 | 0 | 0 | 0 |
| particles 9 | | to measure | | | | | | | |

| | First time | | Second time | | Third time | |
|---|---|---|---|---|---|---|
| | Temperature | Time | Temperature | Time | Temperature | Time |
| Magnetic | 1000° C. | 6 | 1400° C. | 2 hours | 800° C. | 8 |
| particles 1 | | hours | | | | hours |
| Magnetic | 1000° C. | 6 | 1400° C. | 2.5 hours | 850° C. | 8 |
| particles 2 | | hours | | | | hours |
| Magnetic | 1000° C. | 6 | 1400° C. | 2 hours | 800° C. | 6 |
| particles 3 | | hours | | | | hours |
| Magnetic | 1000° C. | 6 | 1400° C. | 2.8 hours | 850° C. | 8 |
| particles 4 | | hours | | | | hours |
| Magnetic | 1000° C. | 8 | 1400° C. | 1.8 hours | 800° C. | 4 |
| particles 5 | | hours | | | | hours |
| Magnetic | 1000° C. | 5 | 1400° C. | 1.8 hours | 800° C. | 8 |
| particles 6 | | hours | | | | hours |

| | | | | | |
|---|---|---|---|---|---|
| Magnetic | None | 1400° C. | 4 hours | 900° C. | 8 |
| particles 7 | | | | | hours |
| Magnetic | None | 1400° C. | 4 hours | 900° C. | 8 |
| particles 8 | | | | | hours |

| | | | | |
|---|---|---|---|---|
| Magnetic | None | 1400° C. | 6 hours | None |
| particles 9 | | | | |

(Preparation of Carrier 1)

2000 g of magnetic particles 1 are put in a vacuum degassing 5 L kneader, 560 g of the coating liquid 1 is further added thereto, and the mixture is mixed for 15 minutes by reducing the pressure thereof to −200 mmHg at 60° C. while stirring, and then the mixture is stirred and dried for 30 minutes under the conditions of 94° C. and −720 mmHg by increasing the temperature thereof and reducing the pressure thereof, thereby obtaining coated particles in which a part of the surface of the magnetic particles 1 are coated with the coating liquid 1. Next, sieving is performed using a sieving net having a mesh of 75 μM, thereby obtaining a carrier 1. The coating rate of the carrier is 96%.

(Preparation of Carriers 2 to 10)

Carriers 2 to 10 are prepared in the same manner as that of the carrier 1 except that the magnetic particles and the coating liquid used for preparing the carrier 1 are respectively changed as listed in Table 2. The coating rates thereof are respectively 96%.

TABLE 2

| | Magnetic particles | Coating liquid |
|---|---|---|
| Carrier 1 | Magnetic particles 1 | Coating liquid 1 |
| Carrier 2 | Magnetic particles 2 | Coating liquid 1 |
| Carrier 3 | Magnetic particles 3 | Coating liquid 1 |
| Carrier 4 | Magnetic particles 4 | Coating liquid 1 |
| Carrier 5 | Magnetic particles 5 | Coating liquid 1 |
| Carrier 6 | Magnetic particles 6 | Coating liquid 1 |
| Carrier 7 | Magnetic particles 7 | Coating liquid 1 |
| Carrier 8 | Magnetic particles 8 | Coating liquid 1 |
| Carrier 9 | Magnetic particles 9 | Coating liquid 1 |
| Carrier 10 | Magnetic particles 1 | Coating liquid 2 |

### Example 1

A developing device in which 10% by mass of the carrier 1 is added to the toner 1 and a cyan developer cartridge in which 10% by mass of the carrier 1 is added to the toner 1 are respectively arranged in DCC400 (manufactured by Fuji Xerox Co., Ltd.) remodeled so as to be printable using cyan alone.

One sheet of a solid image (image density:100%, image A1) having a dimension of 20 cm² is printed in an environment of a temperature of 30° C. and a humidity of 85% RH, and then 500 sheets of halftone images having an image density of 70% are printed.

Next, the environment is moved to an environment of a temperature of 10° C. and a humidity of 15% RH, 50 sheets of white paper are printed, and solid images (image density: 100%, image B1) having a dimension of 20 cm² are printed.

In the same environment, 30000 sheets of halftone images having an image density of 15% are printed and the same printing test is repeatedly performed. That is, the environment is moved to an environment of a temperature of 30° C. and a humidity of 85% RH, one sheet of a solid image (image density:100%, image A2) having a dimension of 20 cm² is printed, and then 500 sheets of halftone images having an image density of 70% are printed. Next, the environment is moved to an environment of a temperature of 10° C. and a humidity of 15% RH, 50 sheets of white paper are printed, and solid images (image density: 100%, image B2) having a dimension of 20 cm² are printed.

The color difference ΔE of each image A1, B1, A2, and B2 is measured. Further, X-RITE938 (manufactured by X-rite, Inc.) is used for measuring the image density and the color difference (ΔE) is measured. The color difference (ΔE) is a square root value of the sum of squares of a distance difference in a L*a*b* space of CIE1976 (L*a*b*) color system. The CIE1976 (L*a*b*) color system is a color space recommended by CIE (International Commission on Illumination) in 1976 and defined in “JIS Z 8729” by Japanese Industrial Standards.

When equations of “ΔE(A1)−ΔE(B1)=ΔE1” and “ΔE(A2)−ΔE(B2)=ΔE2” are verified, the values are as follows.

ΔE1=ΔE(A1)−ΔE(B1)=0.8

ΔE2=ΔE(A2)−ΔE(B2)=1.0

### Examples 2 to 7 and Comparative Examples 1 to 5

Evaluation is performed on a developer in which the carrier 1 in Example 1 is changed to a carrier listed in Table 3 below in the same manner as that of the developer of Example 1. The evaluation results are listed in Table 3.

Further, the term “present” in columns of the “trickle” in Table 3 means that developing is performed by supplying the toner and the carrier to the developing device from the developer cartridge using the trickle type and the term “absent” means that developing is performed by supplying only the toner to the developing device without supplying the carrier thereto using the toner cartridge.

Moreover, evaluation criteria of “ΔE(A1)−ΔE(B1)=ΔE1” and “ΔE(A2)−ΔE(B2)=ΔE2” in Table 3 are as follows.

A: a difference (ΔE1, ΔE2) of ΔE is from 0 to 1.5

B: a difference (ΔE1, ΔE2) of ΔE is from 1.6 to 2.9

C: a difference (ΔE1, ΔE2) of ΔE is from 3.0 to 4.0

D: a difference (ΔE1, ΔE2) of ΔE is 4.1 or more

TABLE 3

| | | | ΔE1 | | ΔE2 | |
|---|---|---|---|---|---|---|
| | Carrier | Trickle | Value | Evaluation | Value | Evaluation |
| Example 1 | Carrier 1 | Present | 0.8 | A | 1.0 | A |
| Example 2 | Carrier 2 | Present | 1.4 | A | 1.6 | B |
| Example 3 | Carrier 3 | Present | 1.8 | B | 2.2 | B |
| Example 4 | Carrier 4 | Present | 1.6 | B | 2.5 | B |
| Example 5 | Carrier 5 | Present | 2.0 | B | 3.0 | C |
| Example 6 | Carrier 10 | Present | 2.8 | B | 3.8 | C |
| Example 7 | Carrier 1 | Absent | 0.8 | A | 2.5 | B |
| Comparative | Carrier 6 | Present | 3.5 | C | 5.5 | D |
| example 1 | | | | | | |
| Comparative | Carrier 7 | Present | 3.2 | C | 5.0 | D |
| example 2 | | | | | | |
| Comparative | Carrier 8 | Present | 4.2 | D | 5.8 | D |
| example 3 | | | | | | |
| Comparative | Carrier 9 | Present | 5.0 | D | 6.3 | D |
| example 4 | | | | | | |
| Comparative | Carrier 6 | Absent | 3.5 | C | 5.9 | D |
| example 5 | | | | | | |

Although magnetic particles 1 are used by both of the carriers 1 and 10 used in Examples 1 and 6, it is assumed that the density unevenness in the image of Example 1 is suppressed due to the difference of the coating liquid (resin-coated layer).

### Example 11

A developing device in which 10% by mass of the carrier 1 is added to the toner 1 and a cyan developer cartridge in which 10% by mass of the carrier 1 is added to the toner 1 are respectively arranged in DCC400 (manufactured by Fuji Xerox Co., Ltd.) remodeled with the reclaim system so as to be printable using cyan alone.

10000 sheets of halftone full images having an image density of 50% are printed in an environment of a temperature of 30° C. and a humidity of 85% RH. Next, solid images (image density: 100%, image A) having a dimension of 10 cm² are printed and then the image quality is confirmed. Further, 10000 sheets of halftone full images having an image density of 50% are printed in an environment of a temperature of 10° C. and a humidity of 15% RH, and then solid images (image density: 100%, image B) having a dimension of 10 cm² are printed.

Evaluation on images A and B is performed through visual inspection. The “fogging” and the “density unevenness” are respectively evaluated with respect to the image A and the image B according to the following criteria.

[Fogging]

A: No fogging

B: Fogging is slightly found by magnifying the image 20 times, but the fogging is not recognized when visually inspected

C: Fogging is thinly generated

D: Fogging is apparently generated

[Density Unevenness]

A: Density unevenness is not generated

B: Density unevenness is slightly generated

C: Density unevenness is somewhat generated

D: Density unevenness is apparently generated

### Examples 12 to 16 and Comparative Examples 11 to 14

Evaluation is performed on a developer in which the carrier 1 in Example 11 is changed to a carrier listed in Table 4 below in the same manner as that of the developer of Example 11. The evaluation results are listed in Table 4.

TABLE 4

| | | Image A | Image B |
|---|---|---|---|
| | Carrier | (fogging) | (density unevenness) |
| Example 11 | Carrier 1 | A | A |
| Example 12 | Carrier 2 | A | B |
| Example 13 | Carrier 3 | C | B |
| Example 14 | Carrier 4 | B | B |
| Example 15 | Carrier 5 | B | B |
| Example 16 | Carrier 10 | A | B |
| Comparative | Carrier 6 | C | D |
| Example 11 | | | |
| Comparative | Carrier 7 | D | C |
| Example 12 | | | |
| Comparative | Carrier 8 | D | D |
| Example 13 | | | |
| Comparative | Carrier 9 | D | D |
| Example 14 | | | |

Although magnetic particles 1 are used by both of the carriers 1 and 10 used in Examples 11 and 16, it is assumed that the density unevenness in the image B of Example 11 is suppressed due to the difference of the coating liquid (resin-coated layer).

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A carrier for developing an electrostatic image, comprising: magnetic particles,
wherein the magnetic particles has a flow rate of 25 sec/50 g to 30 sec/50 g, and
the magnetic particles satisfy an expression of 1.00≦LR/HR≦1.15, wherein HR represents a resistance under an electric field of 19200 V/cm at a temperature of 30° C. and a relative humidity of 85%, and LR represents a resistance under an electric field of 19200 V/cm at a temperature of 10° C. and a relative humidity of 15%.

2. The carrier for developing an electrostatic image according to claim 1,
wherein the magnetic particles include a coating layer containing a resin, and
the resin contains a cyclohexyl group.

3. The carrier for developing an electrostatic image according to claim 1,
wherein a common logarithm of the HR is from 7 to 9.

4. The carrier for developing an electrostatic image according to claim 1,
wherein a weight average molecular weight of the resin is 30000 to 90000.

5. The carrier for developing an electrostatic image according to claim 1, which is used for a trickle type replenishment,
wherein a development is performed while replacing a carrier for developing an electrostatic image accommodated in the developing unit.

6. An electrostatic image developer comprising:
a toner for developing an electrostatic image; and
the carrier for developing an electrostatic image according to claim 1.

7. A developer cartridge which accommodates the electrostatic image developer according to claim 6 and is detachably attached to an image forming apparatus.

8. A process cartridge which is detachably attached to an image forming apparatus, comprising:
a developing unit that accommodates the electrostatic image developer according to claim 6 and develops an electrostatic image formed on a surface of an image holding member as a toner image by using the electrostatic image developer.

9. The process cartridge according to claim 8, further comprising:
a residual toner collecting unit that collects a residual toner remaining on a surface of the image holding member; and
a residual toner conveying unit that conveys the residual toner collected and supplies the residual toner to the developing unit.

10. An image forming apparatus comprising:
an image holding member;
a charging unit that charges a surface of the image holding member;
an electrostatic image forming unit that forms an electrostatic image on the surface of the image holding member charged;
a developing unit that accommodates the electrostatic image developer according to claim 6 and develops the electrostatic image formed on the surface of the image holding member as a toner image by using the electrostatic image developer;
a transfer unit that transfers the toner image formed on the surface of the image holding member to the surface of a recording medium; and
a fixing unit that fixes the toner image transferred to the surface of the recording medium.

11. The image forming apparatus according to claim 10, further comprising a developer cartridge which replenishes the developing unit with the electrostatic image developer,
wherein the image forming apparatus is a trickle type to perform a development while replacing the carrier for developing an electrostatic image accommodated in the developing unit.

12. The image forming apparatus according to claim 10, further comprising:
a residual toner collecting unit collecting a residual toner remaining on the surface of the image holding member; and
a residual toner conveying unit that conveys the residual toner collected and supplies the residual toner to the developing unit.
